(19) United States
(12) Patent Application Publication
(10) Pub. No.: US 2022/0056992 A1
(43) Pub. Date: Feb. 24, 2022

(54) CASE FOR POWER TRANSMISSION DEVICE

(71) Applicant: JATCO LTD, Fuij-shi (JP)

(72) Inventors: Tsutomu ITOU, Fuji-shi (JP); Aya NAKATA, Fuji-shi (JP)

(21) Appl. No.: 17/396,224

(22) Filed: Aug. 6, 2021

(30) Foreign Application Priority Data
Aug. 24, 2020 (JP) 2020-140570

(51) Int. Cl. F16H 57/02

(52) U.S. Cl. CPC F16H 57/02; F16H 2057/02026

(57) ABSTRACT

A case for a power transmission device is configured to be mounted in a vehicle. The case includes an outer peripheral surface including a connection part through which a component accommodated inside of the case is configured to be connected to an electrical part arranged on outside of the case, and a water repellent pattern provided around the connection part on the outer peripheral surface, the water repellent pattern being configured to exhibit a water repellent effect.

### CROSS-REFERENCE TO RELATED APPLICATIONS

This application claims priority to Japanese Application No. 2020-140570 filed on Aug. 24, 2021. The entire disclosure of Japanese Application No. 2020-140570 is hereby incorporated herein by reference.

### TECHNICAL FIELD

The present invention relates to a case for a power transmission device.

### BACKGROUND ART

In electrical components such as a transmission controller, etc., these are sometimes arranged above a case that houses a transmission mechanism. The electrical component is electrically connected to the transmission mechanism with a connection part provided on the top surface of the case interposed (see Japanese Laid-Open Patent Publication No. 2013-147046, for example).

### SUMMARY

Water such as rainwater sometimes accumulates on the top surface of the case. Since impurities such as salt are contained in rainwater, when the accumulated rainwater dries, the impurities such as salt precipitate.

For example, if precipitation of salt occurs around the connection part of the case, the connection part corrodes due to the salt. As a result, there is the risk of problems occurring with the electrical component.

In light of that, there is a need to suppress water that has adhered to the case from being retained on the case.

A case for a power transmission device according to one embodiment is configured to be mounted in a vehicle. The case includes an outer peripheral surface including a connection part through which a component accommodated inside of the case is configured to be connected to an electrical part arranged on outside of the case, and a water repellent pattern provided around the connection part on the outer peripheral surface, the water repellent pattern being configured to exhibit a water repellent effect.

According to an embodiment of the present invention, it is possible to suppress the retention of water on the case.

### BRIEF DESCRIPTION OF THE DRAWINGS

FIG. 1 is a schematic block diagram of a power transmission device.

FIG. 2 is a perspective view of a fourth case.

FIG. 3 is a perspective view of the fourth case.

FIG. 4 is plan view seen from above around a connection part of the fourth case.

FIG. 5 is a main part cross section diagram of the fourth case.

FIG. 6 is a main part cross section diagram of the fourth case.

FIG. 7 is a main part cross section diagram of the fourth case.

FIG. 8 is a main part cross section diagram of the fourth case.

FIG. 9 is a drawing explaining the state of water droplets in a region in which a pattern exhibiting a water repellent effect is provided.

FIG. 10 is a drawing explaining the state of water droplets in a region in which a pattern exhibiting a water repellent effect is not provided.

### DETAILED DESCRIPTION OF EMBODIMENTS

Hereafter, a case for a power transmission device according to an embodiment of the present invention is explained using an example of a reducer case (fourth case 14) of a power transmission device 1 mounted in a vehicle.

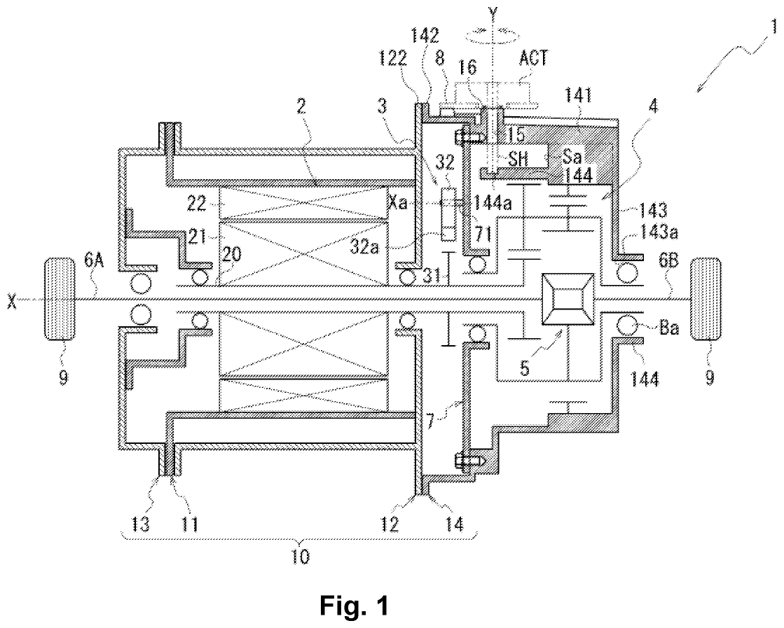

FIG. 1 is a schematic block diagram of the power transmission device 1. In FIG. 1, each constituent element of the power transmission device 1 is shown schematically.

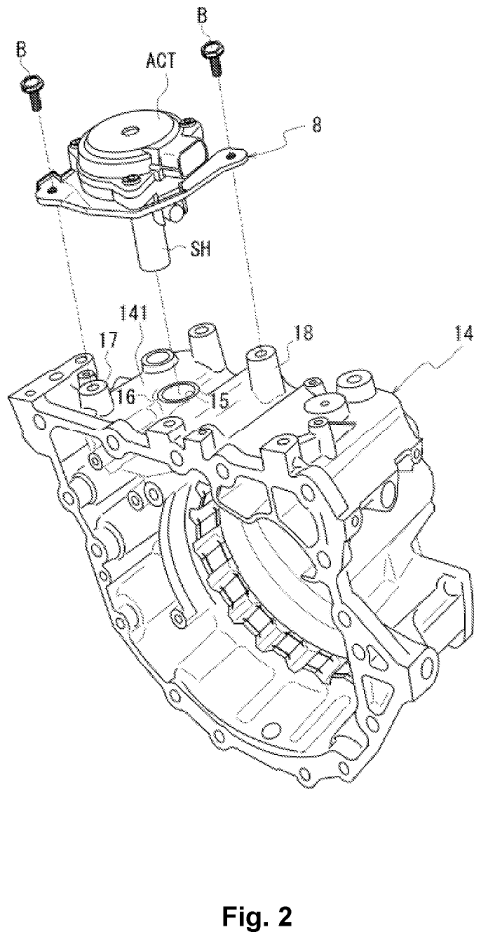

FIG. 2 is a perspective view of the fourth case 14 seen from diagonally above. In FIG. 2, an actuator ACT and a plate member 8 are shown separated from the fourth case 14.

As shown in FIG. 1, a body case 10 of the power transmission device 1 is configured from a first case 11 that houses a motor 2, a second case 12 that is fit on the outside of the first case 11, a third case 13 that is attached to the first case 11, and the fourth case 14 that is attached to the second case 12.

The motor 2 has a rotor core 21 and a stator core 22, and the output rotation of the motor 2 is output from a motor shaft 20 that rotates integrally with the rotor core 21.

With the power transmission device 1, along the transmission path of the output rotation of the motor 2 are provided a parking mechanism 3, a planetary reduction gear 4 (reduction mechanism), a differential mechanism 5, and drive shafts 6A, 6B.

The planetary reduction gear 4 reduces the output rotation of the motor 2 and inputs it to the differential mechanism 5.

The differential mechanism 5 transmits rotation input from the planetary reduction gear 4 to the drive shafts 6A, 6B. As a result, the output rotation of the motor 2 is ultimately transmitted to drive wheels 9, 9 at the left and right of the vehicle in which the power transmission device 1 is mounted, and the vehicle travels.

The parking mechanism 3 has a parking gear 31 and a parking pawl 32.

The parking gear 31 is fit on the outside of the motor shaft 20 and fixed. The parking gear 31 rotates integrally with the motor shaft 20.

The parking pawl 32 is supported to be able to rotate on a support shaft 71 provided on a plate 7.

The parking pawl 32 has an engaging part 32a at a position that is radially outward of a pivot shaft Xa. The engaging part 32a works in conjunction with pivot of the parking pawl 32, and disengages the engaging part 32a at the outer periphery of the parking gear 31.

When the engaging part 32a engages with the outer periphery of the parking gear 31, the rotation of the motor shaft 20 is restricted, and the vehicle in which the power transmission device 1 is mounted goes to a state in which travel is restricted (travel restricted state).

When the engaging part 32a separates from the outer periphery of the parking gear 31, rotation of the motor shaft 20 is allowed, and the vehicle in which the power transmission device 1 is mounted goes to a state in which travel is enabled (travel enabled state).

The power transmission device 1 has an actuator ACT (electrical component) for driving the parking mechanism 3.

The actuator ACT rotates a manual shaft SH around an axis Y based on a command of a control device (not illustrated). When the manual shaft SH rotates around the axis Y, the parking pawl 32 pivots around the pivot shaft Xa in conjunction with rotation of the manual shaft SH. By doing this, the engaging part 32a of the parking pawl 32 disengages at the outer periphery of the parking gear 31, and the vehicle is switched between the travel restricted state and the travel enabled state.

The mechanism that pivots the parking pawl 32 in conjunction with rotation of the manual shaft SH is a conventionally known mechanism, so an explanation is omitted here.

This type of mechanism, as an example, is a mechanism having a manual plate (not illustrated) that rotates integrally with the manual shaft SH, a parking rod (not illustrated) that does forward and reverse movement in conjunction with rotation of the manual plate, and a cam (not illustrated) that pivots the parking pawl in conjunction with the forward and reverse movement of the parking rod.

The actuator ACT is positioned outside the fourth case 14.

The fourth case 14 has a peripheral wall part 141 that surrounds the outer periphery of the planetary reduction gear 4 (reduction mechanism).

With the peripheral wall part 141, a through hole 15 is provided in the upper region with the installed state of the power transmission device 1 in the vehicle as a reference. The through hole 15 penetrates the peripheral wall part 141 in the thickness direction. A boss shaped connection part 16 that surrounds the through hole 15 is provided on the outer periphery of the peripheral wall part 141.

With the through hole 15, the manual shaft SH that extends from the actuator ACT penetrates the interior of the peripheral wall part 141 from outside.

As shown in FIG. 2, with the peripheral wall part 141, bolt boss parts 17, 18 are provided at one side (left side in the drawing) and the other side (right side in the drawing) with the connection part 16 sandwiched in between.

The bolt boss parts 17, 18 extend upward from the peripheral wall part 141, and the plate member 8 that supports the actuator ACT is placed on the top end of the bolt boss parts 17, 18.

The actuator ACT is fixed to the outer periphery of the fourth case 14 by bolts B, B that penetrate the plate member 8 being screwed into the bolt boss parts 17, 18.

As shown in FIG. 1, when the actuator ACT is fixed to the outer periphery of the fourth case 14, the body part of the actuator ACT is joined to the top end of the connection part 16. In this state, the gap between the matching surfaces of the body part and the connection part 16 is sealed using a sealing ring.

On one end of the second case 12 side (left side in the drawing) of the peripheral wall part 141, a flange shaped junction 142 is provided, and at the other end, a wall 143 is provided.

The junction 142 is surrounded along the full periphery of the opening of the second case 12 side of the peripheral wall part 141, and extends radially outward from the outer periphery of the peripheral wall part 141.

The junction 142 of the fourth case 14 is linked by a bolt (not illustrated) to a junction 122 of the second case 12.

The wall 143 extends to the inner diameter side from the other end of the peripheral wall part 141. An insertion hole 143a for the drive shaft 6B is opened on the inner diameter side of the wall 143. A cylindrical support wall 144 that surrounds the insertion hole 143a is provided on the outer periphery of the wall 143. The drive shaft 6B is supported by the support wall 144 to be able to rotate with a bearing Ba interposed.

On the inside of the peripheral wall part 141, the support wall 144 is provided on the inner diameter side of the abovementioned through hole 15.

The support wall 144 is provided with a space Sa opened between it and the inner periphery of the peripheral wall part 141. With the support wall 144, a support hole 144a is opened on the top surface facing the peripheral wall part 141.

In the support hole 144a, the tip of the manual shaft SH that penetrates the abovementioned through hole 15 is inserted, and is supported to be able to rotate.

The base end side of the manual shaft SH projects to the outside of the fourth case 14 from the connection part 16 of the outer periphery of the fourth case 14. The actuator ACT is linked to the projecting region of the manual shaft SH.

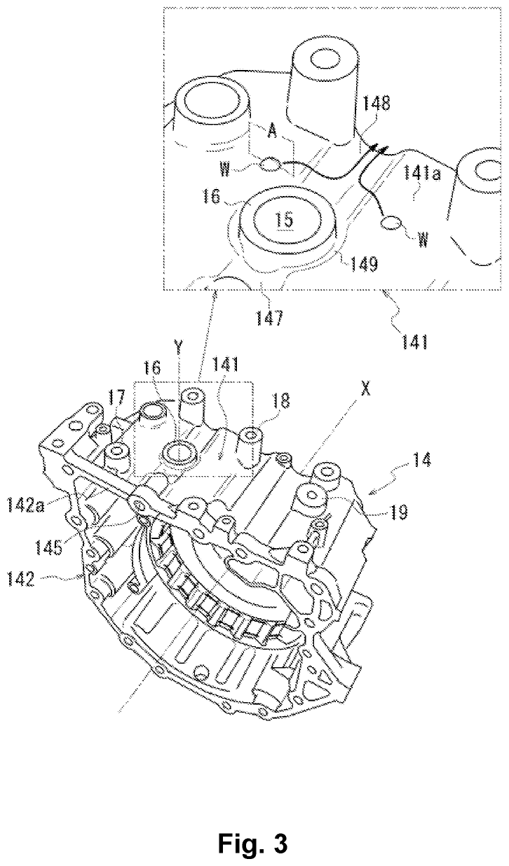

FIG. 3 is a perspective view of the fourth case 14 seen from diagonally above. FIG. 3 shows with arrows the movement trajectory of water droplets W adhered to the surface of the peripheral wall part 141.

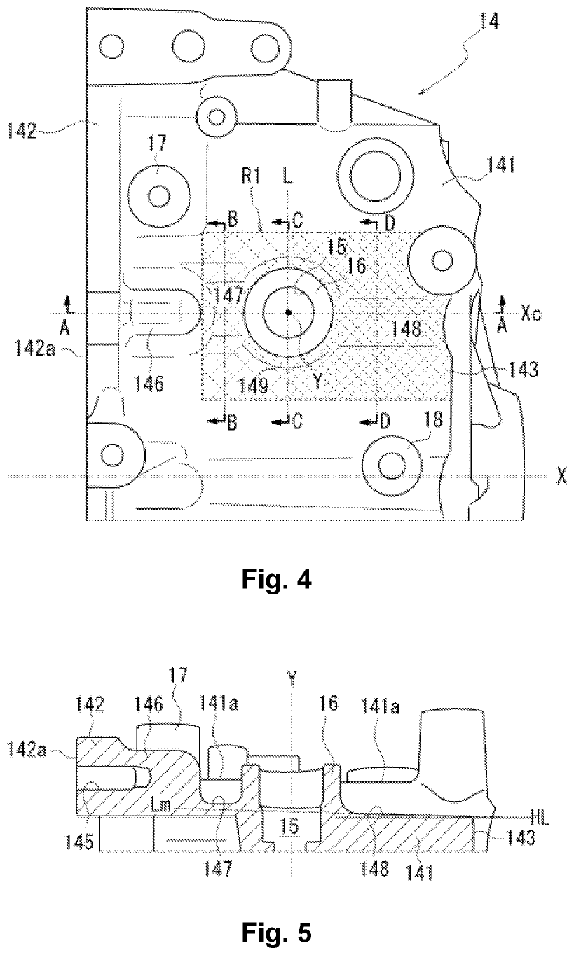

FIG. 4 is a plan view of the fourth case 14 seen from above, and is a drawing showing an enlarged view around the connection part 16. In FIG. 4, a region R1 in which a pattern that exhibits a water repellent effect is provided is shown marked by cross hatching.

FIG. 5 is a cross section view with the fourth case 14 cut along line A-A of FIG. 4.

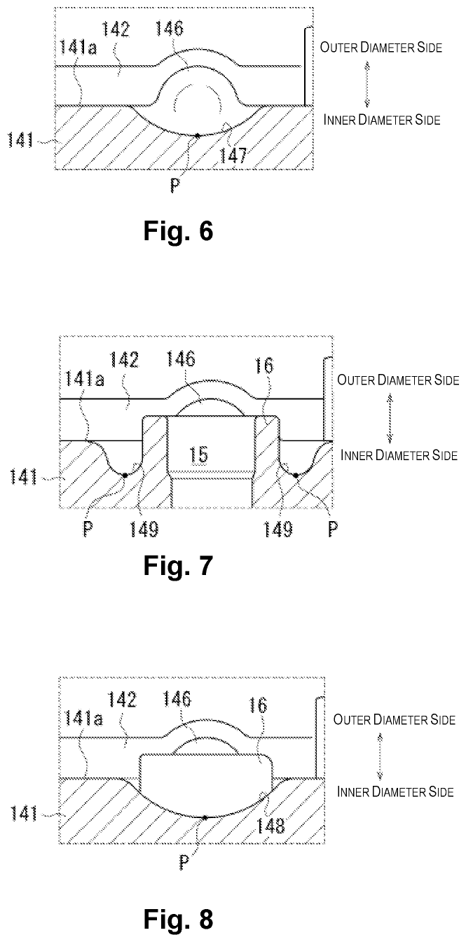

FIG. 6 is a cross section view with the fourth case 14 cut along line B-B of FIG. 4.

FIG. 7 is a cross section view with the fourth case 14 cut along line C-C of FIG. 4.

FIG. 8 is a cross section view with the fourth case 14 cut along line D-D of FIG. 4.

As shown in FIG. 3, in the fourth case 14, the connection part 16 projects from a surface 141a which is the outer peripheral surface of the peripheral wall part 141.

More specifically, in the peripheral wall part 141, the connection part 16 projects facing upward from the surface 141a of the region positioned on the upper side with the state of the power transmission device 1 installed in the vehicle as the reference.

As shown in FIG. 4, in the plan view of the fourth case 14 seen from above, with the peripheral wall part 141, a rib 146 is provided at the junction 142 side (left side in the drawing) seen from the connection part 16.

As shown in FIG. 5, the rib 146 is a part that surrounds a bolt hole 145 opened in an end surface 142a of the junction 142. The rib 146 bulges upward from the surface 141a of the fourth case 14.

As shown in FIG. 4 and FIG. 5, the rib 146 extends up to the vicinity of the connection part 16 following a straight line Xc from the end surface 142a of the junction 142. Here, the straight line Xc is a straight line parallel to a rotation axis X, and is a straight line following the joining direction of the fourth case 14 and the second case 12.

A recess 147 is formed between the rib 146 and the connection part 16 in the straight line Xc direction.

As shown in FIG. 6, in the cross section view, the recess 147 has an arc-shaped cross section with a peak P facing the inner diameter side. The region in which the recess 147 and the surface 141a of the peripheral wall part 141 are connected has an arc-shaped cross section with the peak facing the outer diameter side.

For that reason, in the cross section view, the surface 141a of the peripheral wall part 141 and the recess 147 are continuous without steps.

As shown in FIG. 4 and FIG. 5, with the peripheral wall part 141, at the side opposite to the rib 146 (right side in the drawing) seen from the connection part 16, a recess 148 is formed. The recess 148 extends to the wall 143 of the fourth case 14 following the abovementioned straight line Xc.

As shown in FIG. 8, in the cross section view, the recess 148 has an arc-shaped cross section with the peak P facing the inner diameter side. The region in which the recess 147 and the surface 141a of the peripheral wall part 141 are connected has an arc-shaped cross section with the peak facing the outer diameter side.

For that reason, in the cross section view, the surface 141a of the peripheral wall part 141 and the recess 148 are continuous without steps.

As shown in FIG. 7, arc-shaped recesses 149, 149 are formed on both sides of the connection part 16 following the outer periphery of the connection part 16. In the cross section view, the recesses 149 have an arc-shape with the peak P facing the inner diameter side. As shown in FIG. 4, seen from the connection part 16, the recess 147 positioned at one side and the recess 148 positioned at the other side are joined to each other with the arc-shaped recess 149 interposed.

As shown in FIG. 5, the surface of the recess 148 is slightly inclined with respect to a horizontal line HL. In the cross section view, the recess 148 is inclined in a direction so that the wall 143 side (right side in the drawing) is slightly lower than the connection part 16 side (left side in the drawing).

The abovementioned recess 147 is positioned further to the outer diameter side than a virtual line Lm that passes through the deepest position of the recess 148, and the recess 147 has a depth from the surface 141a that is shallower than the recess 148.

With the power transmission device 1, there are undulations due to ribs, bosses, etc., on the surface of the body case 10. When water such as rainwater, etc., acts on the body case 10, there is a possibility of moisture remaining locally on the surface of the body case 10 due to the undulations.

When moisture remaining on the surface of the body case 10 evaporates, salt, etc., contained in the moisture accumulates. The accumulated salt can become a cause of corrosion.

For example, having moisture remain around a boss for attachment, and having salt accumulate (salting out) is not desirable because it is necessary for the boss for attachment which is the connection part with the electrical component to have support stability with the electrical component.

For that reason, with the body case 10 of the present embodiment, a water repellent pattern that exhibits a water repellent effect is provided to the surface of the body case 10, at least on the surface of the region where it is wished to not have moisture remain.

As an example, with the fourth case 14, the connection part 16 is provided as the boss for attaching the actuator ACT.

With this fourth case 14, the water repellent pattern that exhibits a water repellent effect is provided to the surface of the region around the connection part 16.

More specifically, as shown in FIG. 4, the water repellent pattern that exhibits a water repellent effect is applied to the region R1 marked by cross hatching around the connection part 16. With this region R1, the connection part 16 is positioned approximately in the center. Furthermore, the region R1 is set in a range straddling the abovementioned straight line Xc from one side to the other side, and the abovementioned recesses 147, 148 are positioned at approximately the center in the direction orthogonal to the straight line Xc.

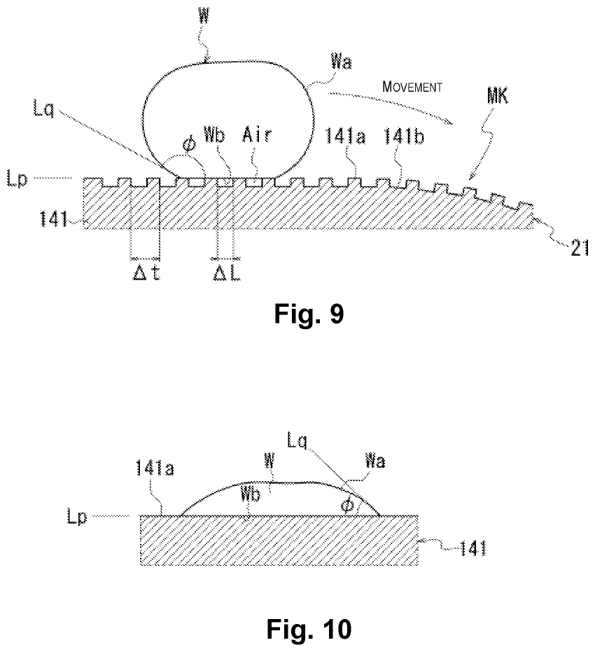

FIG. 9 is a cross section view of region A in FIG. 3, and is a drawing that explains the state of water droplets W in the region in which pattern MK (example of a water repellent pattern) that exhibits a water repellent effect is provided.

In FIG. 9, the cross section of the region in which the pattern MK that exhibits a water repellent effect is provided is shown enlarged schematically.

FIG. 10 is a drawing that explains the state of the water droplets W in the region in which the pattern MK that exhibits a water repellent effect is not provided.

As shown in FIG. 9, with the present embodiment, a so-called “nashiji” (a textured surface like an Asian pear skin) pattern is used as the pattern MK that exhibits a water repellent effect.

As an example, the textured pattern is formed with a plurality of recesses 141b provided on the region R1 (see FIG. 4) on the surface 141a of the peripheral wall part 141. With the surface 141a within the region R1, the recesses and projections continue alternately, and in the cross section view there is a recess and projection shape.

The recesses 141b may be formed when casting the fourth case 14, but may also be formed by implementing surface processing on the fourth case 14 after casting.

Here, the width ΔL of the recess 141b is set to a width in which the water droplet W adhered to the surface will not infiltrate inside the recess 141b, 5 to 15 for example. The gap ΔT of adjacent recesses 141b is set to 20 to 30 μm, for example.

By setting in this way, it is possible to suitably prevent the adhered water droplets W from entering inside the recesses 141b, and a layer of air Air due to the recesses 141b is formed at the interface Wb of the water droplets W with the surface 141a.

With the interface Wb of the water droplets W, the regions in contact with the surface 141a and the regions in contact with the air Air inside the recesses 141b are in an alternately repeated state (Cassie-Baxter state).

In the Cassie-Baxter state, the angle φ formed by the interface Wb and the surface Wa in the water droplets W (angle formed by straight line Lp and straight line Lq, also marked as contact angle φ) is 90 degrees or greater (see FIG. 9).

When the contact angle φ is 90 degrees or greater, the Lotus effect is exhibited, and the wettability of the water droplets on the surface 141a is lowered, specifically, the water repellency of the surface 141a inside the region R1 is increased.

The pattern MK that exhibits a water repellent effect is sufficient provided it is a textured pattern that can have water droplets W in a Cassie-Baxter state, and is not limited to being a nashiji finish pattern.

It may also be a pattern with recesses randomly aligned at intervals for which the Cassie-Baxter state can be realized. Also, instead of a nashiji pattern, it is also possible to use a hairline pattern.

The effect of the fourth case 14 that has the region R1 provided with the pattern MK that exhibits a water repellent effect on the surface is explained.

When moisture adheres to the surface of the body case 10 of the power transmission device 1, in the region R1 of the fourth case 14 in which the pattern MK that exhibits a water repellent effect is provided, the water repellency of the surface 141a is high, so a plurality of water droplets W are formed on the surface.

When the vehicle is traveling, a wind flow due to travel is formed along the surface of the body case 10, and vibration, etc., caused by traveling acts on the body case 10.

The water droplets W that occur in the region R1 have low wettability with the surface 141a, so they are pushed by the flow of air along the surface 141a of the fourth case 14, and move without being retained at a specific location on the surface 141a.

For example, in the case of FIG. 3, after moving to the recess 148, the water droplets that occurred on the surface 141a for which water repellency increased are discharged through the recess 148 to outside from the fourth case 14 (see the arrows in the drawing).

The water droplets W also move by the vibration that acts on the body case 10.

For example, on the surface 141a with increased water repellency, the water droplets that occurred around the recess 148 slide down into the recess 148 due to vibration, after which they move along the slight incline of the recess 148, and finally are discharged to outside from the fourth case 14. Thus, it is possible to suitably suppress retention of the water droplets W.

In this way, it is possible to suitably suppress retention of the water droplets W at specific locations on the fourth case 14, and after the retained water droplets W have evaporated, the precipitation (salting out) of salt at locations where the water droplets W were retained. Thus, it is possible to suitably suppress corrosion of the fourth case 14 due to precipitated salt.

As described above, the pattern that exhibits a water repellent effect is provided around the connection part 16 with the actuator ACT. For that reason, it is possible to suitably suppress having moisture remain around the connection part 16 and having salting out occur in the connection part 16. This makes it possible to ensure support stability of the actuator ACT (electrical component) in the connection part 16.

Meanwhile, when the region R1 given the pattern that exhibits a water repellent effect is not set on the surface 141a of the fourth case 14, the layer of air Air such as that shown in FIG. 9 is not formed on the interface Wb at which the surface 141a and the water droplets W are in contact.

In this case, as shown in FIG. 10, with the water droplets W, the contact angle 9 of the interface Wb with the surface 141a and the surface Wa of the water droplet is 0 degrees or greater and less than 90 degrees. In this case, the Lotus effect is not exhibited, so the wettability of the water droplets W with respect to the surface 141a increases. Specifically, the water repellency of the surface 141a becomes lower.

When the Lotus effect is not exhibited, because the contact angle is small, the water droplets W on the surface 141a do not move easily even if acted on by air flow or vibration.

That being the case, when water droplets W are retained locally, and the retained water droplets W evaporate, salt that was contained in the water droplets more easily precipitate in the region in which the water droplets W were retained.

As described above, in the region R1 given the pattern that exhibits a water repellent effect, the water droplets W that adhered to the surface are not easily retained locally. For that reason, by setting the region R1 given the pattern that exhibits a water repellent effect so as to surround the region in which to avoid salting out on the fourth case 14, it is possible to suitably suppress the occurrence of salting out in the region in which it is desired to avoid salting out.

With the present embodiment, an example was shown of a case of the region R1 given the pattern MK that exhibits a water repellent effect being set in the periphery of the connection part 16. The region R1 given the pattern MK that exhibits the water repellent effect is not limited only to the mode described above.

It is also possible to provide this so as to cover along the entire surface of the fourth case 14. It is also possible to provide this only in the region arranged on the upper side of the surface of the fourth case 14 with the state of the power transmission device 1 installed in the vehicle as the reference.

Also, in the region R1 of FIG. 4, it is also possible to provide this only in the region in which the cross hatching density is dense, specifically, looking from the connection part 16, the wall 143 side (region on the right side in the drawing), and to have only the water droplets W of a specific region be discharged outward from the fourth case 14.

Giving the pattern MK that exhibits a water repellent effect can also be performed in post-processing, so it is possible to suppress salting out by providing the pattern MK that exhibits a water repellent effect at the desired site in the fourth case 14.

Furthermore, it is also possible to provide guides (recesses 147, 148, 149) that guide the water droplets W to outside the fourth case 14, and to set the region R1 given the pattern MK that exhibits a water repellent effect in these guides on the surface 141a and the region adjacent to these guides.

In this case, it is possible to actively discharge the generated water droplets W facing out from the fourth case 14.

Also, in addition to the connection part 16, when wishing to prevent salting out to around other sites in the fourth case 14 (for example, another bolt boss part 19, see FIG. 3), by further providing the pattern MK that exhibits the water repellent effect to surround the bolt boss part 19, it is possible to properly protect the bolt boss part 19 as well.

As described above, the fourth case 14 (reducer case) of the present embodiment has the following configurations.

(1) The fourth case 14 has a boss shaped connection part 16 that is provided for connection of the actuator ACT (electrical part) to the surface 141a that is the outer peripheral surface of the peripheral wall part 141.

With the fourth case 14, the pattern MK that exhibits a water repellent effect is applied around the connection part 16.

By configuring in this way, it is possible to quickly drain water in the periphery of the connection part 16 of the fourth case 14 (reducer case).

Since it is possible to quickly move water in the periphery of the connection part 16 without having water retained in the periphery of the connection part 16, it is possible to suppress the effect of salting out due to retained moisture. Thus, it is possible to ensure support stability of the actuator ACT (electrical component) in the connection part 16.

(2) The actuator ACT (electrical part) is the electrical part for driving the manual shaft SH of the parking mechanism 3.

The through hole 15 of the connection part 16 is penetrated by the manual shaft SH.

By configuring in this way, it is possible to quickly drain water in the periphery of the connection part 16 penetrated by the manual shaft SH.

(3) The pattern MK that exhibits a water repellent effect is a textured pattern.

By configuring in this way, the surface 141a of the peripheral wall part 141 can obtain a water repellent effect by having the surface around the connection part 16 be a textured pattern.

(4) The textured pattern is formed using a recess and projection shape in the cross section view of the surface.

By configuring in this way, by providing recesses and projections on the surface of the fourth case 14 (reducer case), a textured pattern is formed on the surface 141a that is the outer peripheral surface of the fourth case 14, and it is possible to exhibit a water repellent effect in the region of the surface 141a given the textured pattern.

With the present embodiment noted above, of the four cases (first case 11, second case 12, third case 13, and fourth case 14) that constitute the body case 10 of the power transmission device 1, an example was shown of providing the pattern that exhibits a water repellent effect (textured pattern) on the surface of the reducer case that houses the reduction mechanism (fourth case 14).

When there is a region that has a surface exposed to outside it is desired to protect by avoiding salting out on the surface of the second case 12 or the third case 13 as well, it is also possible to provide the pattern that exhibits a water repellent effect in the region of the surface of the second case 12 or third case 13 there is a desire to protect.

The present invention is not limited to the embodiments noted above. Various modifications and improvements that can be done within the scope of the technical concept are included.

What is claimed is:

1. A case for a power transmission device configured to be mounted in a vehicle, the case comprising:
an outer peripheral surface including a connection part through which a component accommodated inside of the case is configured to be connected to an electrical part arranged on outside of the case; and
a water repellent pattern provided around the connection part on the outer peripheral surface, the water repellent pattern being configured to exhibit a water repellent effect.

2. The case according to claim 1, wherein
the connection part defines a through hole through which a manual shaft of a parking mechanism of the vehicle is configured to be inserted, the manual shaft being connected to the electrical part configured to drive the manual shaft.

3. The case according to claim 1, wherein
the water repellent pattern is a textured pattern.

4. The case according to claim 2, wherein
the water repellent pattern is a textured pattern.

5. The case according claim 3, wherein
the textured pattern is defined by a plurality of recesses and a plurality of projections in a cross sectional view.

6. The case according claim 4, wherein
the textured pattern is defined by a plurality of recesses and a plurality of projections in a cross sectional view.
